(19) United States
(12) Patent Application Publication
(10) Pub. No.: US 2008/0201492 A1
(43) Pub. Date: Aug. 21, 2008

(54) DIGITAL MULTI-FUNCTION PERIPHERAL, DIGITAL MULTI-FUNCTION PERIPHERAL SYSTEM, AND CONTROL METHOD FOR DIGITAL MULTI-FUNCTION PERIPHERAL SYSTEM

(75) Inventor: Katsuhiro Nigorikawa, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/675,416

(22) Filed: Feb. 15, 2007

(51) Int. Cl. G06F 3/00

(52) U.S. Cl. 710/11

(57) ABSTRACT

A digital multi-function peripheral includes a function executing unit that executes plural functions including a printing function and a network communication function and a control circuit that controls this function executing unit. The control circuit includes a cooperation control unit that checks connection to a network, selectively combines the functions of the function executing unit with functions unique to other digital multi-function peripherals present on the network, and controls cooperation of these functions.

### BACKGROUND OF THE INVENTION

1. Field of the Invention

The present invention generally relates to a digital multi-function peripheral having functions such as scanning, printing, and copying of images, and, more particularly to a digital multi-function peripheral, a digital multi-function peripheral system, and a control method for the digital multifunction peripheral system that are used in a network environment.

2. Description of the Related Art

Today, a large number of business establishments introduce plural digital multi-function peripherals in order to create prints necessary for businesses. These digital multi-function peripherals have print options concerning file formats of print data, page description language (PDL) formats, print color formats such as color and monochrome, and finish formats such as sorting and stapling. A PDL is a language for causing a multi-function peripheral to interpret a character position and a character type during printing. In general, these print options depend on functional specifications of the digital multi-function peripherals. For example, in a multi-function peripheral for color printing, it is possible to set both print colors of color and monochrome. On the other hand, in a multi-function peripheral for monochrome printing, it is possible to set only a print color of monochrome. Therefore, a user needs to grasp functional specifications of the plural digital multi-function peripherals in advance and, when the user executes printing, select for himself/herself a digital multi-function peripheral in which desired print option items can be designated.

However, it is not easy for the user to grasp functional specifications of all the digital multifunction peripherals in advance. Therefore, it often occurs that, when one of these digital multi-function peripherals is selected and instructed to perform printing in a computer connected to these digital multi-function peripherals via a network such as a local area network (LAN), an undesired print result is often caused because designation of print option items is not appropriate. For example, even if a multi-function peripheral for monochrome printing is selected and full-color print data is transmitted to this multi-function peripheral, it is impossible to obtain a full-color print result.

When print data is described in a PDL that is not an object of treatment of a digital multi-function peripheral selected, a print error occurs. In particular, a print error due to a PDL is serious in that printing is completely impossible. If all the multi-function peripherals are constituted to be capable of performing raster image processing (RIP) for converting various PDLs into a raster image, which is an actual print image, such a problem does not occur.

However, since this RIP requires high-performance hardware, the RIP makes it difficult to provide digital multi-function peripherals inexpensively. In addition, types of PDLs tend to increase in recent years. For example, the PDF is a document format obtained by developing the PostScript, which is a type of the PDLs. The PDF is emerging as a technique that does not require conversion into a PDL in printing. Since software and hardware of the existing digital multi-function peripherals cannot cope with new formats that will emerge in future as described above, cost performance easily falls. It is unrealistic from the viewpoint of the frequency of use to provide a color printing unit and a finish processing unit as standard equipment in order to eliminate a restriction on print options.

Incidentally, for example, JP-A-2004-118868 discloses a technique for providing a dedicated server that selects an optimum printer apparatus present on a network. However, in this technique, the dedicated server is required and, moreover, this dedicated server has to be always maintained in an operating state. As a result, convenience for users is spoiled. JP-A-2004-291629 discloses a technique for selecting an optimum printer apparatus without requiring a dedicated server. However, in this technique, since print data is merely transferred to the printer apparatus selected, the frequency of use of a specific printer apparatus increases. Moreover, these publicly-known documents cannot cope with the increase in the types of PDLs described above.

### BRIEF SUMMARY OF THE INVENTION

It is an object of the invention to provide a digital multi-function peripheral, a digital multi-function peripheral system, and a control method for the digital multi-function peripheral system that can improve convenience for users in a network environment.

According to a first aspect of the invention, there is provided a digital multi-function peripheral including a function executing unit that executes plural functions including a printing function and a network communication function and a control circuit that controls this function executing unit. The control circuit includes a cooperation control unit that checks connection to a network, selectively combines the functions of the function executing unit with functions unique to other digital multi-function peripherals present on the network, and controls cooperation of these functions.

According to a second aspect of the invention, there is provided a digital multi-function peripheral system including plural digital multi-function peripherals provided on a network, respectively. Each of the digital multi-function peripherals includes a function executing unit that executes plural functions including a printing function and a network communication function and a control circuit that controls this function executing unit. The control circuit includes a cooperation control unit that checks connection to a network, selectively combines the functions of the function executing unit with functions unique to other digital multi-function peripherals present on the network, and controls cooperation of these functions.

According to a third aspect of the invention, there is provided a control method for a digital multi-function peripheral system including plural digital multi-function peripherals provided on a network. Each of the digital multi-function peripherals includes a function executing unit that executes plural functions including a printing function and a network communication function and a control circuit that controls this function executing unit. The control method includes checking connection of each of the digital multi-function peripherals to a network, selectively combining the functions of the function executing unit of this digital multi-function peripheral with functions unique to other digital multi-function peripherals present on the network, and controlling cooperation of these functions.

In the digital multi-function peripheral, the digital multi-function peripheral system, and the control method for the digital multi-function peripheral system, the functions of the function executing unit of the digital multi-function peripheral are selectively combined with functions unique to other digital multi-function peripherals present on the network and cooperation of these functions is controlled. This cooperation makes it possible to use the functions unique to the other digital multi-function peripherals and can reduce a restriction on functional options that depend on the functional specifications of the function executing unit. It becomes unnecessary to grasp functional specifications of all the digital multi-function peripherals present on the network in advance. Moreover, only addition of a single digital multi-function peripheral is required in order to make it possible to use the peculiar functions in all the digital multi-function peripherals. Therefore, it is possible to improve convenience for users in the network environment.

Incidentally, if each of the digital multi-function peripherals further checks that other digital multi-function peripherals are not present on the network, acquires functional specifications of all digital multi-function peripherals connected to this network later as cooperation information, and delivers this cooperation information to all the digital multi-function peripherals in order to make it possible to specify digital multi-function peripherals that should functionally cooperate with one another, a dedicated server is not required for management of the cooperation information. Further, since each of the digital multi-function peripherals does not need to independently access the other digital multi-function peripherals in order to obtain the cooperation information, it is possible to prevent an increase in network traffic.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a digital multi-function peripheral system according to an embodiment of the invention;

FIG. 2 is a diagram showing an example of a structure of each of digital multifunction peripherals shown in FIG. 1;

FIG. 3 is a flowchart showing cooperation information management processing performed when the digital multi-function peripheral shown in FIG. 2 is in a network environment shown in FIG. 1;

FIG. 4 is a diagram showing an example in which the three digital multi-function peripherals shown in FIG. 1 cooperate with one another in execution of printing requested by a computer; and

FIG. 5 is a diagram for explaining a cooperative operation between the computer and the three digital multi-function peripherals shown in FIG. 4.

### DETAILED DESCRIPTION OF THE INVENTION

A digital multi-function peripheral system according to an embodiment of the invention will be hereinafter explained with reference to the accompanying drawings.

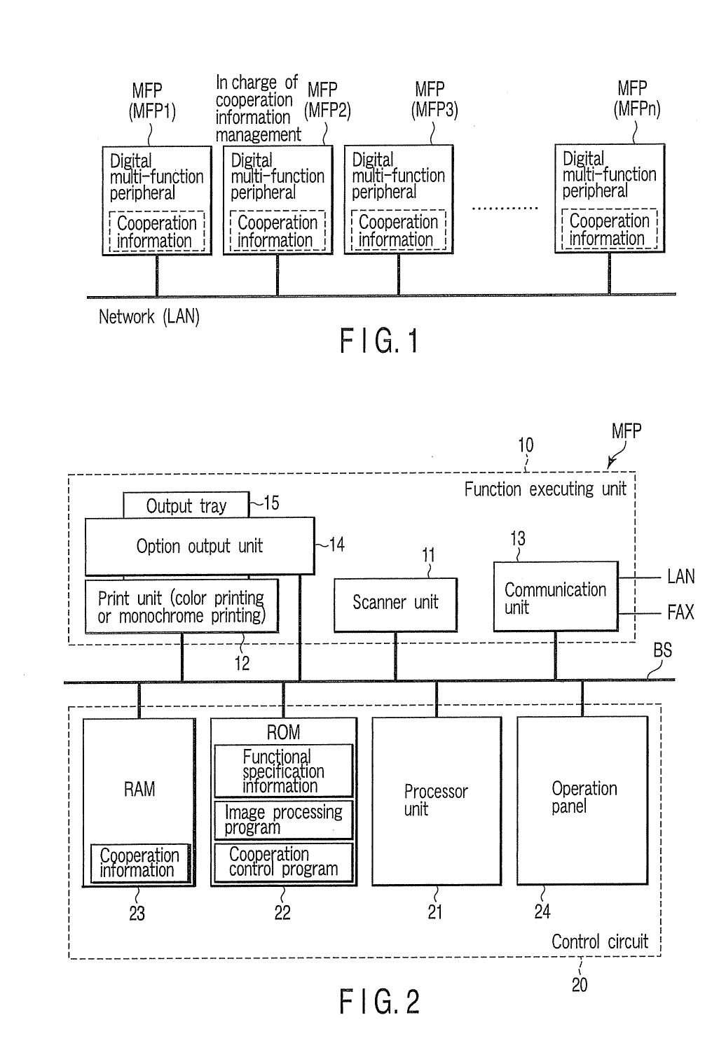

FIG. 1 is shows this digital multi-function peripheral system. The digital multi-function peripheral system includes plural digital multi-function peripherals MFP (MFP1 to MFPn) provided on a network such as a local area network (LAN). These digital multi-function peripherals MFP1 to MFPn are connected to one another by wire or radio.

FIG. 2 shows an example of a structure of the digital multi-function peripheral MFP. The digital multi-function peripheral MFP includes a function executing unit 10 that executes functions such as scanning, printing, and copying of images, network (LAN) communication, and facsimile (FAX) communication and a control circuit 20 that controls this function executing unit 10.

The function executing unit 10 has a scanner unit 11 that scans, for example, an image of an original, a print unit 12 that prints an image on a sheet in color or monochrome, a communication unit 13 that performs LAN communication and FAX communication, an detachable option output unit 14 that applies sorting and stapling to a print obtained from the print unit 12, and an output tray 15 on which the print outputted from the print unit 12 or the option output unit 14 is placed. The scanner unit 11 is provided in order to scan an image of an original for, for example, copying, FAX transmission, or computer edition. The print unit 12 is provided in order to print, for example, an image scanned by the scanner unit 11, an image FAX-received by the communication unit 13, and an image corresponding to print data from an external computer connected to the communication unit 13 via the network.

The control circuit 20 has a processor unit 21 that performs various kinds of data processing, a ROM 22 that stores a control program for this processor unit 21 and fixed data, a RAM 23 that temporarily stores various data inputted to and outputted from the processor unit 21, and an operation panel 24 provided as a user interface to the processor unit 21. The processor unit 21, the ROM 22, the ROM 23, the operation panel 24, the scanner unit 11, the print unit 12, the communication unit 13, and the option output unit 14 are mutually connected by a control bus BS.

The control program includes an image processing program and a cooperation control program and the fixed data includes functional specification information representing the functional specification of the function executing unit 10. The image processing program is provided in order to cause the processor unit 21 to perform image processing such as conversion of image data from a bitmap format to other file formats, conversion of print data from a PDL format to a print image (a raster image), resolution conversion, and correction. The processor unit 21 constitutes a part of the function executing unit 10 during execution of the image processing program. The cooperation control program is provided in order to manage functional specifications of the plural digital multi-function peripherals MFP1 to MFPn present on the network as shown in FIG. 2 as cooperation information and cause, on the basis of this cooperation information, the processor unit 21 to perform selection and processing sharing of a group of digital multi-function peripherals MFP that should cooperate with one another. The processor unit 21 constitutes a cooperation control unit that selectively combines the functions of the function executing unit 10 with functions unique to other digital multi-function peripherals present on the network during execution of the cooperation control program and controls cooperation of these functions. The functional specifications of the function executing unit 10 include, for example, scanning functional specifications such as a maximum original size and a scanning resolution related to the scanner unit 11, print functional specifications such as types of sheet sizes and types of print colors related to the printer unit 12, communication functional specifications such as types of communication systems such as a LAN and a FAX, resolution, and communication speed related to the communication unit 13, image processing functional specifications such as types of object PDLs related to the processor unit 21, and finish functional specifications such as sorting and stapling related to the option unit 14. The operation panel 24 is a display of a touch panel system that displays, for example, menu selection keys, functional option item selection keys, numerical value input keys, and pictures and messages and with which key input is possible.

Since the scanning functional specifications, the print functional specifications, the communication functional specifications, the image processing functional specifications, the finish functional specifications, and the like described above are arbitrarily determined, a structure of the function executing unit 10 is usually different among the digital multi-function peripherals MFP1 to MFPn. All of the digital multi-function peripherals MFP1 to MFPn do not have to have the scanning function, the finish function, and the FAX communication function. On the other hand, a structure of the control circuit 20 is common in sections related to cooperative control of the digital multi-function peripherals MFP1 to MFPn.

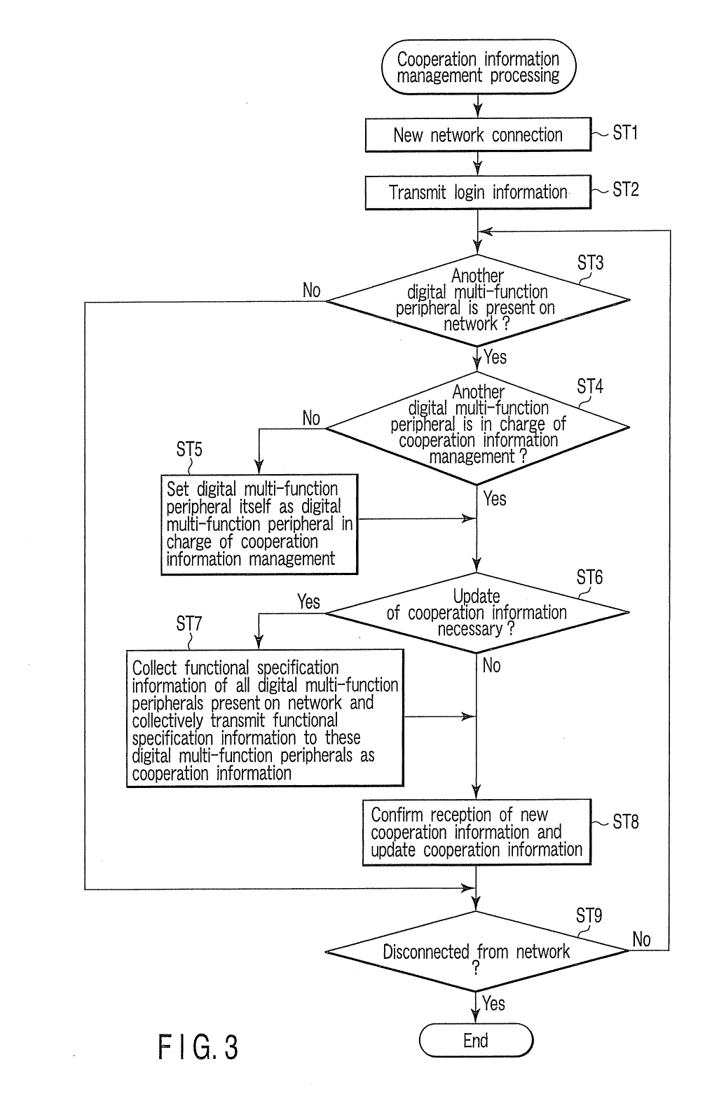

FIG. 3 shows cooperation information management processing that is performed when the respective digital multi-function peripherals MFP are in the network environment shown in FIG. 1. In this network environment, the processor unit 21 executes the cooperation control program according to input of a power supply and performs the cooperation information management processing as shown in FIG. 3 in accordance with this cooperation control program. When the cooperation information management processing is started, for example, in the digital multi-function peripheral MFP2, in step ST1, the processor unit 21 initializes the communication unit 13 for LAN communication and establishes new network connection. In step ST2, the communication unit 13 transmits login information to the network. In step ST3, it is checked whether another digital multi-function peripheral MFP is already present on the network. If the another multi-function peripheral MFP is present, in step ST4, it is checked whether the another digital multi-function peripheral MFP is in charge of cooperation information management.

If the another digital multi-function peripheral MFP is not in charge of cooperation information management, this digital multi-function peripheral MFP2 itself is set to be in charge of cooperation information management in step ST5. In step ST6, it is checked whether update of the cooperation information is necessary. If this digital multi-function peripheral MFP2 itself is in charge of cooperation information management, it is determined that update of the cooperation information is necessary. In step ST6, functional specification information of all the digital multi-function peripherals MFP present on the network is collected and collectively transmitted to all the digital multi-function peripherals MFP as cooperation information. The functional specification information represents functional specifications such as a scanning function, a print function, a communication function, an image processing function, and a finish function. The cooperation information is stored in the RAM 23 in advance in order to perform selection and processing sharing of a group of the digital multi-function peripherals MFP that should cooperate with one another.

However, even if the digital multi-function peripheral MFP2 itself is in charge of cooperation information management, when a predetermined time has not elapsed from the last storage of the cooperation information in a state in which new login information is not received, it is determined in step ST6 that update of the cooperation information is unnecessary. When there is a digital multi-function peripheral MFP, functional specification information of which cannot be acquired for more than a fixed time in the collection of functional specification information performed in step ST7, it is determined that this digital multi-function peripheral MFP is disconnected from the network. This determination is reflected on the cooperation information.

In step ST8, it is confirmed that new cooperation information is received and the cooperation information stored in the RAM 23 is updated to the new cooperation information. In step ST9, it is checked whether the digital multi-function peripheral MFP2 itself is disconnected from the network. If the digital multi-function peripheral MFP2 is disconnected, this cooperation information management processing is finished. On the other hand if the digital multi-function peripheral MFP2 is not disconnected, step ST3 is executed again.

When it is confirmed in step ST3 that another digital multi-function peripheral MFP is not present on the network, step ST9 is executed. When it is confirmed in step ST4 that the another digital multi-function peripheral MFP is in charge of cooperation information management, step ST6 is executed. Moreover, when it is determined in step ST6 that update of the cooperation information is unnecessary, step ST9 is executed.

As a result of adopting the cooperation information management processing described above, a first digital multi-function peripheral MFP connected to the network or a digital multi-function peripheral MFP on the network that has confirmed earliest that the first digital multi-function peripheral MFP is disconnected from the network is determined as an only digital multi-function peripheral in charge of cooperation information management shown in FIG. 1. The cooperation information is delivered, at appropriate frequency, from the digital multi-function peripheral MFP in charge of cooperation information management to all the digital multi-function peripherals MFP that are capable of cooperating with one another on the network, whereby these digital multi-function peripherals MFP are updated to hold the latest cooperation information always.

In the digital multi-function peripheral system shown in FIG. 1, the processor unit 21 of each of the digital multi-function peripheral MFP performs control of cooperation with the other digital multi-function peripherals MFP in parallel to the cooperation information management processing described above in accordance with the cooperation control program. This leads to a result that the difference of the functional specifications among the digital multi-function peripherals MFP present on the network is eliminated. Therefore, for example, when the print function is used, it is possible to request execution of printing without selecting a specific digital multi-function peripheral MFP in advance.

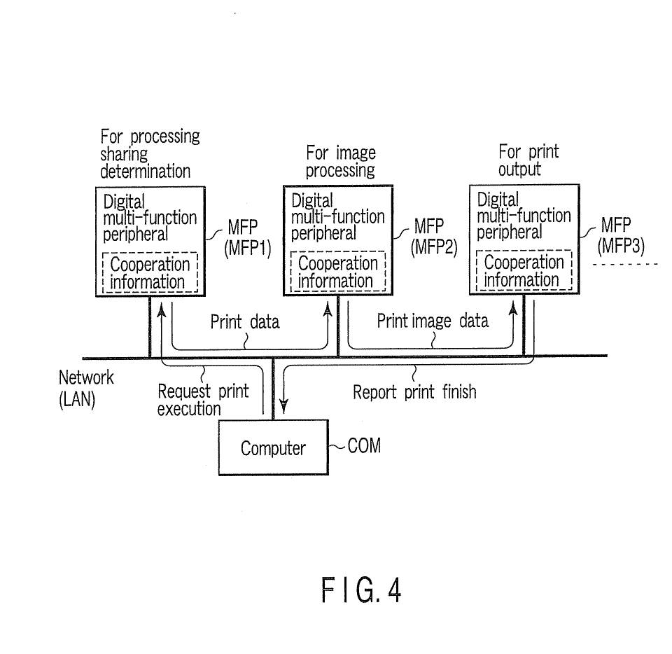

An example of the cooperation control described above will be hereinafter explained. FIG. 4 shows an example in which the three digital multi-function peripherals MFP1 to MFP3 shown in FIG. 1 cooperate with one another in execution of printing requested from a computer COM provided on the network. When the computer COM requests the digital multi-function peripheral MFP1 to execute printing, the digital multi-function peripheral MFP1 determines, on the basis of the cooperation information, selection and processing sharing of a group of the digital multi-function peripherals MFP1 to MFP3 that should cooperate with one another. When the processing sharing is determined, for example, the digital multi-function peripheral MFP2 performs image processing for print data from the digital multi-function peripheral MFP1. The digital multi-function peripheral MFP3 prints print image data obtained from the digital multi-function peripheral MFP2 on a sheet and outputs the print image data and reports this print end to the computer COM.

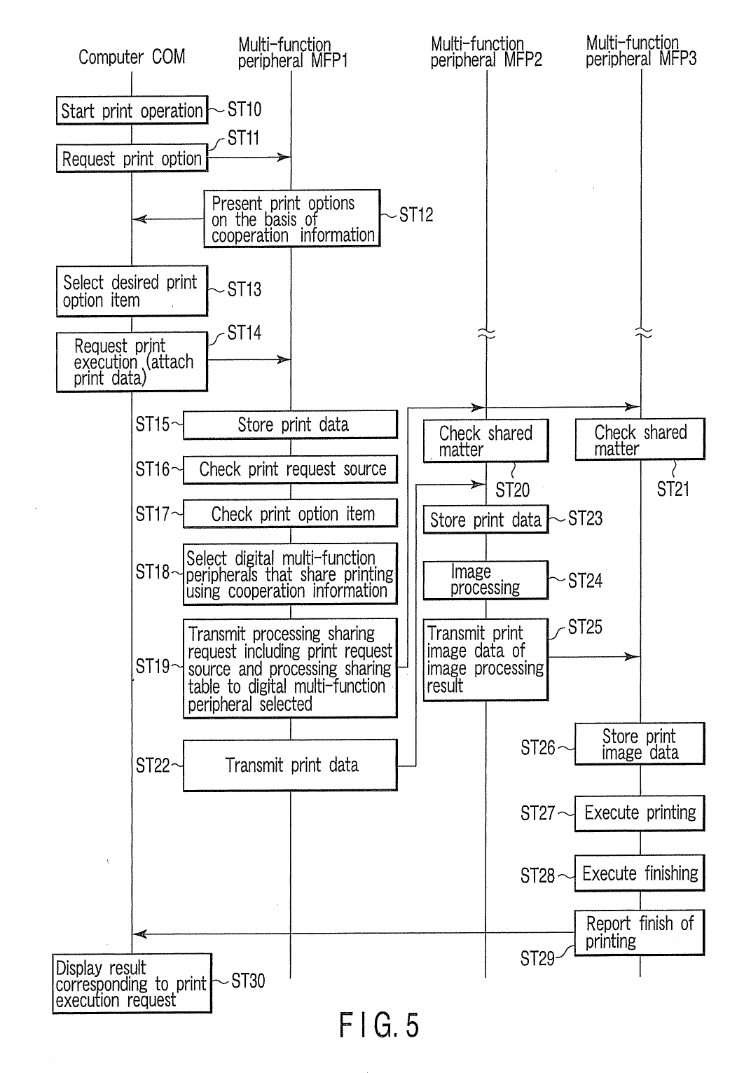

A cooperative operation between the computer COM and the three digital multi-function peripherals MFP1 to MFP3 described above is performed by the microprocessors 21 provided in the digital multi-function peripherals MFP1 to MFP3, respectively, for example, as shown in FIG. 5. When print operation by the computer COM is started in step ST10, in step ST11, a print option request is transmitted to the digital multi-function peripheral MFP1. In step ST12, the digital multi-function peripheral MFP1 presents usable print options to the computer COM on the basis of the cooperation information. In step ST13, the computer COM selects a desired print option item and, in step ST14, requests the digital multi-function peripheral MFP1 to execute printing of print data conforming to the print option item selected.

In step ST15, the digital multi-function peripheral MFP1 stores the print data, in step ST16, checks a print request source, i.e., the computer COM, and, in step ST17, checks the print option item. In step ST18, in addition to the digital multi-function peripheral MFP1, for example, the digital multi-function peripherals MFP2 and MFP3 are selected as digital multi-function peripherals MFP that share printing. Here, the digital multi-function peripherals MFP2 and MFP3 are digital multi-function peripherals conforming to the print option item selected and are combined by using the cooperation information delivered in the cooperation information management processing shown in FIG. 3. In the subsequent step ST19, a processing sharing request including the print request source and a processing sharing table is delivered to the digital multi-function peripherals MFP2 and MFP3 selected.

The digital multi-function peripherals MFP2 and MFP3 check a shared matter in steps ST20 and ST21, respectively. In step ST22, the digital multi-function peripheral MFP1 transmits the print data to the digital multi-function peripheral MFP2 after the delivery of the processing sharing request. In step ST23, the digital multi-function peripheral MFP2 stores the print data received, in step ST24, applies image processing to this print data, and, in step ST25, transmits a result of this image processing to the digital multi-function peripheral MFP3. In step ST27, the digital multi-function peripheral MFP3 stores the print image data received, in step ST27, executes printing of this print image data, and, in step ST28, executes finishing of a print of a result of this printing. The printing in step ST27 is executed using the print unit 12. The finishing in step ST28 is executed using the option unit 14. When the print is outputted to an output tray, in step ST29, a printing finish report is transmitted from the digital multi-function peripheral MFP3 to the computer COM at the print request source. Subsequently, in step ST30, the computer COM presents a result corresponding to the print execution request, i.e., the finish of the printing to the user.

When an error occurs in the cooperative operation, the error is directly reported from a digital multi-function peripheral MFP in which the error occurs, i.e., any one of the digital multi-function peripherals MFP1 to MFP3 to the computer COM at the print request source. In the digital multi-function peripheral MFP2, transmission of the print image data is performed in step ST25 after completion of the image processing for the print data performed in step ST24. However, when a processing data quantity is large, partial print image data attached with processing sharing information is transmitted to the digital multi-function peripheral MFP3 in the middle of the image processing every time print image data is partially obtained. In the example described above, the computer COM is used in order to perform a print option request, selection of a print option item, and a print execution request. However, when the copying function is used, the operation panel 24 of an arbitrary digital multi-function peripheral MFP, for example, the digital multi-function peripheral MFP1 is used.

In the digital multi-function peripheral system according to this embodiment, the functions of the function executing unit 10 of each of the digital multi-function peripherals MFP are selectively combined with functional specifications unique to the other digital multi-function peripherals MFP present on the network and cooperation of these functions are controlled. This cooperation makes it possible to use functions unique to the other digital multi-function peripherals MFP and can reduce restriction on functional options that depend on the functional specifications of the function executing unit 10. It becomes unnecessary to grasp functional specifications of all the digital multi-function peripherals MFP present on the network in advance. Moreover, only addition of a single digital multi-function peripheral MFP is required in order to make it possible to use the peculiar functions in all the digital multi-function peripherals MFP. Therefore, it is possible to improve convenience for users in the network environment.

In addition to the above, each of the digital multi-function peripherals MFP further confirms that other digital multi-function peripherals MFP are not present on the network, acquires functional specifications of all the digital multi-function peripherals MFP connected to this network later as cooperation information, and delivers this cooperation information to all the digital multi-function peripherals MFP in advance in order to make it possible to specify digital multi-function peripherals MFP that should functionally cooperate with one another. Even when plural digital multi-function peripherals MFP are already present on the network and a digital multi-function peripheral MFP in charge of cooperation management information management is disconnected from the network, any one of the remaining digital multifunction peripherals MFP can replace the digital multi-function peripheral MFP as a digital multi-function peripheral MFP in charge of cooperation information management. Incidentally, since the digital multi-function peripheral MFP with a higher processing ability more easily finds a state in which the cooperation information is not managed, it is possible to obtain a preferable tendency that the digital multi-function peripheral MFP with a higher processing ability becomes a new digital multi-function peripheral MFP in charge of cooperation information management. In such a system, a dedicated server is not required for management of the cooperation information. Further, since each of the digital multi-function peripherals MFP does not need to independently access the other digital multi-function peripherals MFP in order to obtain the cooperation information, it is possible to prevent an increase in network traffic.

In the embodiment described above, in step ST18, the digital multi-function peripheral MFP1 determines the digital multi-function peripheral MFP3 as a digital multi-function peripheral MFP for print output. However, candidates of a digital multi-function peripheral MFP usable for print output may be presented to the computer COM to entrust final determination to a user who is an operator of the computer COM.

When image processing in the digital multi-function peripheral MFP2 is high load, the digital multi-function peripheral MFP2 may select plural digital multi-function peripherals MFP, which perform image processing in parallel, and independently deliver a processing sharing request to a digital multi-function peripherals MFP selected. Similarly, when image processing in the digital multi-function peripheral MFP2 is high load, the digital multi-function peripheral MFP3 may select plural digital multi-function peripherals MFP, which perform print output in parallel, and independently deliver a processing sharing request to the digital multi-function peripherals MFP selected. In other words, when a high load is applied to a single digital multi-function peripheral MFP in a process for processing a request, it is possible to reduce a processing time by dividing the processing and executing the processing in parallel. For example, it is also possible to increase speed of color adjustment, color matching, PDL filter processing, and the like by distributing the processing to a desired number of digital multi-function peripherals MFP.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital multi-function peripheral comprising:
a function executing unit configured to execute plural functions including a printing function and a network communication function; and
a control circuit that controls the function executing unit, wherein
the control circuit includes a cooperation control unit configured to check connection to a network, selectively combine the functions of the function executing unit with functions unique to other digital multi-function peripherals present on the network, and control cooperation of these functions.

2. A digital multi-function peripheral according to claim 1, wherein the cooperation control unit acquires functional specifications of all the digital multi-function peripherals present on the network as cooperation information, confirms that cooperation information management for delivering this cooperation information to all the digital multi-function peripherals is not performed on the network, and performs the cooperation information management.

3. A digital multi-function peripheral according to claim 2, wherein the cooperation information is updated according to at least connection of a new digital multi-function peripheral to the network.

4. A digital multi-function peripheral according to claim 2, wherein a combination of the functions is determined on the basis of the cooperation information.

5. A digital multi-function peripheral according to claim 1, wherein the function executing unit includes at least one of a scanning function, a facsimile communication function, an image processing function, and a finishing function as an executable function other than the printing function and the network communication function.

6. A digital multi-function peripheral according to claim 1, wherein the cooperation control unit reports, when processing requiring cooperation of the functions is requested via the network, finish of the processing to a request source.

7. A digital multi-function peripheral according to claim 6, wherein the request source is a computer.

8. A digital multi-function peripheral system comprising plural digital multi-function peripherals provided on a network, respectively, each of the digital multi-function peripherals including a function executing unit configured to execute plural functions including a printing function and a network communication function and a control circuit that controls this function executing unit, wherein
the control circuit includes a cooperation control unit configured to check connection to a network, combine the functions of the function executing unit with functions unique to other digital multi-function peripherals present on the network, and control cooperation of these functions.

9. A digital multi-function peripheral system according to claim 8, wherein the cooperation control unit acquires functional specifications of all the digital multi-function peripherals present on the network as cooperation information, confirms that cooperation information management for delivering this cooperation information to all the digital multi-function peripherals is not performed on the network, and performs the cooperation information management.

10. A digital multi-function peripheral system according to claim 9, wherein the cooperation information is updated according to at least connection of a new digital multi-function peripheral to the network.

11. A digital multi-function peripheral system according to claim 9, wherein a combination of the functions is determined on the basis of the cooperation information.

12. A digital multi-function peripheral system according to claim 8, wherein the function executing unit includes at least one of a scanning function, a facsimile communication function, an image processing function, and a finishing function as an executable function other than the printing function and the network communication function.

13. A digital multi-function peripheral system according to claim 8, wherein the cooperation control unit reports, when processing requiring cooperation of the functions is requested via the network, finish of the processing to a request source.

14. A digital multi-function peripheral according to claim 13, wherein the request source is a computer.

15. A control method for a digital multi-function peripheral system including plural digital multi-function peripherals provided on a network, each of the digital multi-function peripherals including a function executing unit configured to execute plural functions including a printing function and a network communication function and a control circuit that controls this function executing unit, the control method comprising:
checking connection of each of the digital multi-function peripherals to a network;
combining the functions of the function executing unit of this digital multi-function peripheral with functions unique to other digital multi-function peripherals present on the network; and
controlling cooperation of these functions.

16. A control method according to claim 15, further comprising acquiring functional specifications of all the digital multi-function peripherals present on the network as cooperation information, confirming that cooperation information management for delivering this cooperation information to all the digital multi-function peripherals is not performed on the network, and causing any one of the plural digital multi-function peripherals to perform the cooperation information management.

17. A control method according to claim 16, wherein the cooperation information is updated according to at least connection of a new digital multi-function peripheral to the network.

18. A control method according to claim 16, wherein a combination of the functions is determined on the basis of the cooperation information.

19. A control method according to claim 1, wherein the function executing unit includes at least one of a scanning function, a facsimile communication function, an image processing function, and a finishing function as an executable function other than the printing function and the network communication function.

20. A control method according to claim 1, wherein, when processing requiring cooperation of the functions is requested via the network, finish of the processing reported to a request source.
